(19) United States
(12) Patent Application Publication
(10) Pub. No.: US 2017/0195797 A1
(43) Pub. Date: Jul. 6, 2017

(54) PLANAR LOUDSPEAKER MEMBRANE FOR WIDE FREQUENCY RANGE SOUND REPRODUCTION AND SPEAKER UTILIZING SAME

(71) Applicant: Fitzroy Engineering, LLC, dba Live-Wall, Chula Vista, CA (US)

(72) Inventor: Ricardo LAZZARI, Chula Vista, CA (US)

(21) Appl. No.: 14/782,530

(22) PCT Filed: Apr. 7, 2014
(86) PCT No.: PCT/US2014/033168

§ 371 Date: Oct. 5, 2015

Related U.S. Application Data
(60) Provisional application No. 61/809,003, filed on Apr. 5, 2013.

(51) Int. Cl. H04R 7/10; H04R 9/06; H04R 9/02; H04R 1/28

(52) U.S. Cl. CPC H04R 7/10; H04R 1/288; H04R 9/06; H04R 9/025

(57) ABSTRACT

Provided is a substantially flat loudspeaker membrane assembly, optimized for wide-frequency-range sound reproduction. A combination of a stiff and lightweight material for a main membrane with a direct voice-coil attachment region, and a damping secondary membrane provides wide and uniform frequency response and low distortion reproduction equivalent to conventional speakers, with a single voice coil.

### PRIORITY

This application claims priority to U.S. Provisional Application No. 61/809,003, filed Apr. 5, 2013, the contents of which is incorporated herein by reference.

### BACKGROUND OF THE INVENTION

1. Field of the Invention

The present invention relates generally to flat membrane speakers and, in particular, to a planar speaker having a membrane optimized for wide-frequency range sound reproduction.

2. Description of the Related Art

Conventional planar loudspeakers, i.e., speakers, as used to reproduce a wide frequency range, i.e., 50-20,000 Hz, exist in numerous forms. However, conventional speakers are either aesthetically unacceptable for contemporary interior design or lack a true mechanical piston-like behavior, wherein all points in front of a driving piston move with the same displacement, needed for high-quality sound reproduction. Conventional membranes used in speakers to provide high-quality sound reproduction are also limited in shape. In addition, such speaker membranes can not be painted, and are typically concealed by positioning behind a grill for in-wall or in-ceiling installations.

Although planar loudspeaker membranes used for full-range audio reproduction have been conceived in several different forms, conventional speakers lack either the wide frequency extension required by high-quality sound reproduction, or are non-symmetrical by design and are limited in linearity and audio performance.

Performance limitations of conventional speaker designs, together with a need for aesthetically-pleasing solutions for wide-frequency-range sound reproduction, call for a novel design approach, as provided herein.

### SUMMARY OF THE INVENTION

The present invention overcomes the above-described shortcomings of conventional speakers and provides a flat sound-radiating membrane assembly of bonded layers defining a high stiffness, low weight central membrane for high-frequency sound reproduction, and a high damping surrounding area for lower frequency sound reproduction, absorption of high frequencies, and control of normal vibration modes, separated by transition region. One or more additional layers are sequentially bonded to form layers to provide further control of normal modes at low frequencies, while maintaining a flat, paintable exterior face.

An aspect of the present invention provides a sound reproduction apparatus that includes a main membrane, a plurality of damping membranes, and a plurality of adhesive layers, with a first adhesive layer of the plurality of adhesive layers bonding a front surface of a first damping membrane of the plurality of damping membranes to a rear surface of the main membrane, and a second adhesive layer of the plurality of adhesive layers bonding a rear surface of the first damping membrane to a front surface of a second damping membrane of the plurality of damping membranes, with the plurality of damping membranes being of non-uniform thickness, thereby providing improved control of vibration characteristics of the main membrane at low and mid frequencies.

Another aspect of the present invention provides method of wide-frequency sound reproduction that includes driving a main membrane via a voice coil, with the main membrane bonded by an adhesive layer to a damping membrane, with a modulus of elasticity of the main membrane being greater than 15 GPa and a modulus of elasticity of the damping membrane being less than 3 GPa.

### BRIEF DESCRIPTION OF THE DRAWINGS

The above and other objects, features and advantages of certain exemplary embodiments of the present invention will be more apparent from the following detailed description, taken in conjunction with the accompanying drawings, in which:

FIG. 1 is a rear perspective view of a round sound reproduction apparatus of an embodiment of the present invention;

FIG. 2 is an exploded view of FIG. 1;

FIG. 3 is a perspective view of a damping membrane of FIG. 1, further including filleted corners;

FIG. 4 is a rear perspective view of the sound reproduction apparatus with a damping membrane according to another embodiment of the present invention;

FIG. 5 is a cross-section of the sound reproduction apparatus of FIG. 4, mounted on a supporting frame;

FIG. 6 is an exploded view of FIG. 4;

FIG. 7 is a front perspective view of a loudspeaker with a membrane assembly of the present invention;

FIG. 8 is a rear perspective view of FIG. 7;

FIG. 9 is a rear perspective view of a speaker assembly of a preferred embodiment;

FIG. 10 is an exploded view of FIG. 9;

FIG. 11 is a rear perspective view of a loudspeaker with a membrane assembly that includes an additional damping membrane, according to another embodiment of the present invention;

FIG. 12 is a rear perspective view of a loudspeaker membrane assembly according to a further embodiment of the present invention;

FIG. 13 is an exploded view of FIG. 12;

FIG. 14 compares far-field sound pressure level of a conventional single-layer membrane to the loudspeaker of FIG. 7 in shaded and solid lines, respectively;

FIG. 15 compares near-field sound pressure level of a conventional single-layer membrane and the loudspeaker of FIG. 7 in shaded and solid lines, respectively; and

FIG. 16 compares free-air impedance of a conventional single-layer membrane to the loudspeaker of FIG. 7 in shaded and black lines, respectively.

### DETAILED DESCRIPTION OF THE PREFERRED EMBODIMENTS

The following detailed description of preferred embodiments of the invention will be made in reference to the accompanying drawings. In describing the invention, explanation of related functions or constructions known in the art are omitted for the sake of clarity in understanding the concept of the invention and to avoid obscuring the invention with unnecessary detail.

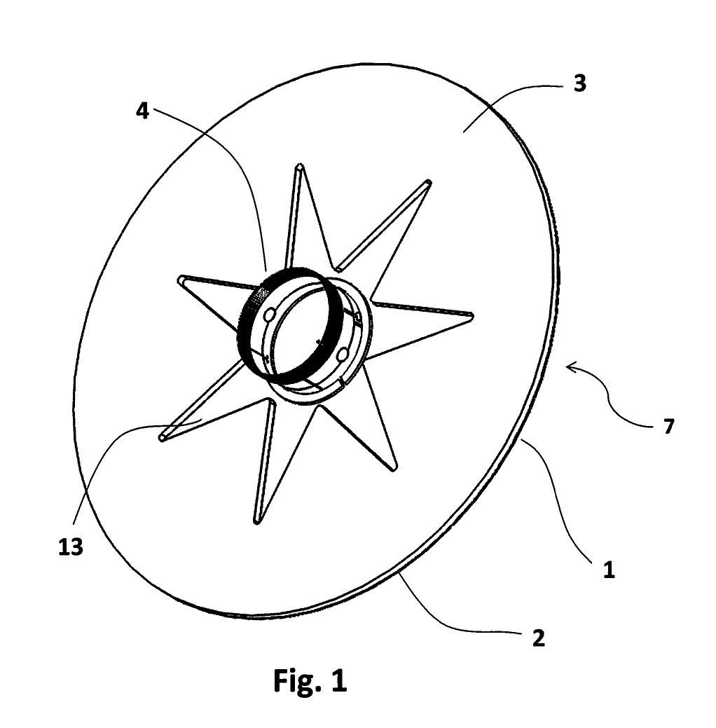

A flat, sound-radiating multi-level membrane assembly is provided that includes layers of varied, specific properties. The plurality of layers of the membrane are bonded together to provide a central membrane area with high stiffness and low weight, with the central membrane area providing high-frequency sound reproduction. A high damping surrounding area is provided for optimized sound reproduction at lower frequencies, to absorb high frequencies and control normal vibration modes, with a transition zone provided between inner peaks and outer peaks of a star cutout 13 (FIGS. 1-4, 6-7 and 9-13).

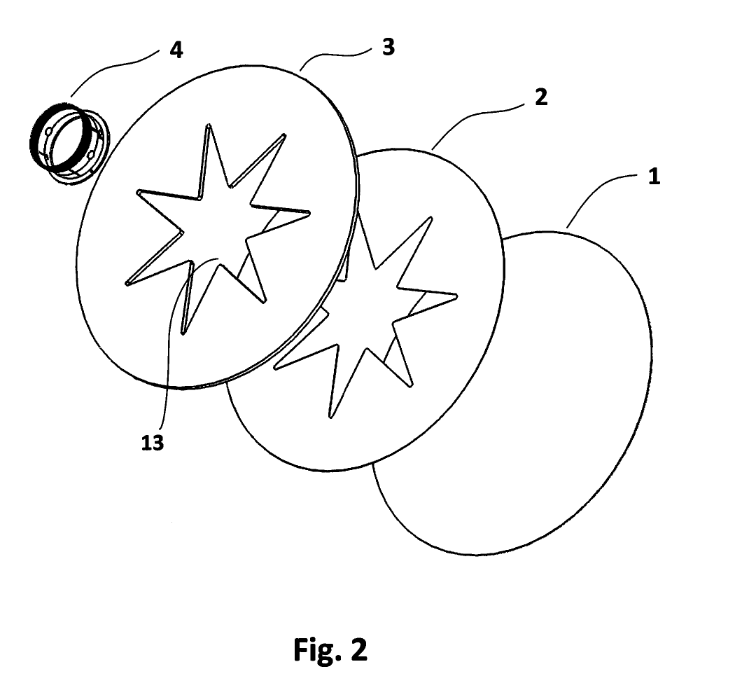

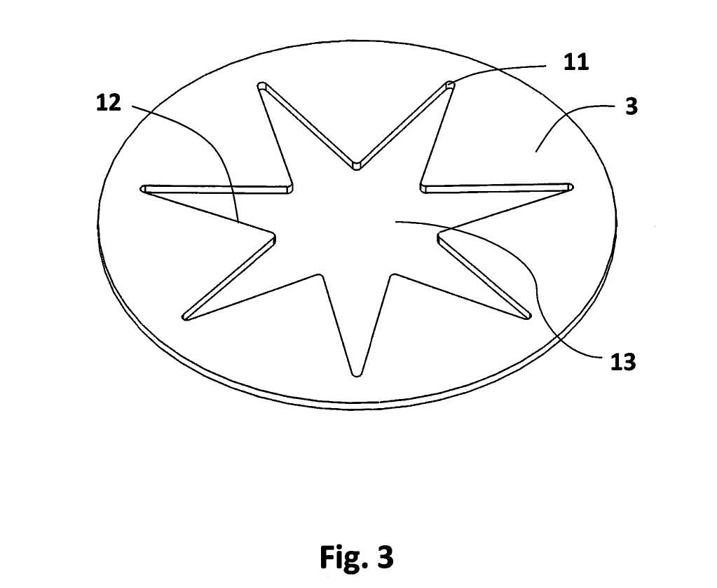

FIG. 1 provides a rear perspective view of a round speaker membrane assembly of a sound reproduction apparatus of a first embodiment of the present invention, FIG. 2 provides an exploded view of FIG. 1, and FIG. 3 provides a perspective view of a damping membrane 3 shown in FIG. 1, with a star cutout 13 therein. The star cutout 13 in damping membrane 3 can, in preferred embodiments, include filleted corners 11 (FIG. 3) with a radius of 1% to 10% the length of corresponding straight sides 12. In addition, lack of symmetry, i.e., providing an odd number of points, in star cutout 13 reduces density on normal modes, and an odd number of points, e.g., seven, is preferred over a symmetrical cutout with an even number of points.

Accordingly, a round version of membrane assembly 7 is provided with a thin, flat main membrane 1 and a damping membrane 3, i.e., secondary membrane, bonded together by adhesive layer 2. Voice coil 4 is also provided, selected in terms of impedance, diameter, winding length, number of layers, etc., for each specific application.

The exploded view of FIG. 2 separately shows various components, in particular thin adhesive layer 2 between main membrane 1 and damping membrane 3. Adhesive layer 2 contributes to overall damping of damping membrane 3, due to inter-layer friction and heat dissipation. Although adhesive layer 2 is preferably laminated on one face of damping membrane 3, elastic spray-on or roll-on adhesives can provide adhesive layer 2, depending on preferred manufacturing method.

Accordingly, membrane assembly 7 is provided for a transducer to optimize wide-frequency audio reproduction using a magnetic circuit of voice coil 4, attached to an internal, rear face of main membrane 1. The magnetic circuit of voice coil 4 preferably uses ceramic, alnico or rare-earth magnets, or an electro-magnet, with the voice coil optimized for size, material, wire type, number of layers, and other parameters for each specific application. Using classic design theory, see John William Strutt, The Theory of Sound, Vol. 1, Dover Publ., 2nd Ed., (1945), and J. E. Benson, Theory and Design of Loudspeaker Enclosures, Amalgamated Wireless Australasia Technical Review, Vol. 14, No. 1 (1968), and Finite-Element Analysis (FEA), materials were chosen based on performance prediction of the membrane assembly when used as part of a full-range loudspeaker, and electro-mechanical-acoustical parameters were chosen to model the performance of the transducer. Extensive FEA and prototyping during development of the preferred embodiments identified suitability of stiff and lightweight membranes combined with a secondary damping-control membrane layer for uniform reproduction of broadband audio frequencies, typically ranging from 50 Hz to above 20 kHz, and the same analysis identified that similar performance can be achieved utilizing membranes of different shapes, with round and quadrilateral shapes described herein as preferred embodiments.

A Modulus of Elasticity (E) of main membrane 1 is greater than 15 GPa, though very small transducers and headphones can provide similar performance goals employing membranes with significantly smaller Modulus of Elasticity, provided that the layer of the damping membrane 3 is proportionally more elastic.

Choice of material for each component is an important factor. For example, the piston and main membrane of the low-frequency membrane described in Publication WO/2013/082594 of co-owned Appln. No. PCT/US2012/067597, can be used as main membrane 1 and damping membrane 3, respectively.

For main membrane 1, a lightweight, stiff material is used having a Modulus of Elasticity (E) greater than 15 GPa, e.g., aluminum (E=69 GPa), fiberglass laminate (E between 17.0 and 22.0 GPa), carbon fiber (E between 150 GPa and 180 GPa), and honeycomb or similar cellular panels (E greater than 15 GPa). The materials of main membrane 1 are preferably one of fiberglass, carbon fiber, phenolic laminates, metal, typically aluminum, and lightweight honeycomb, stiff cellular panels. The main membrane material is very stiff compared to the high-damping material of damping membrane 3, and at least ten times stiffer, to ensure suitable performance.

Damping membrane 3, which is preferably die-cut or molded, is formed of one of synthetic foam, plastic sheet, fiberboard and foam board. The Modulus of Elasticity of the damping membrane material is preferably less than 3 Gpa, with high internal losses to control normal vibration modes. Damping membrane 3 can made of materials that include solid or foamed plastic sheet (E between 1.0 and 2.0 GPa), foam board (E<0.1 GPa), open or closed-cell foam sheet (E<0.1 GPa), fiberboard or other materials with similar damping properties.

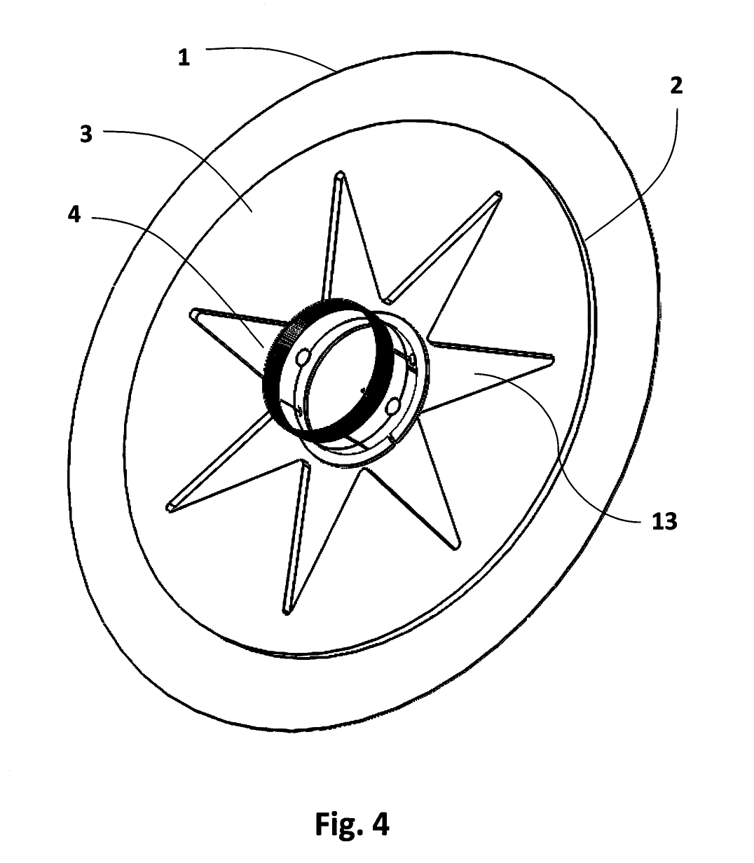

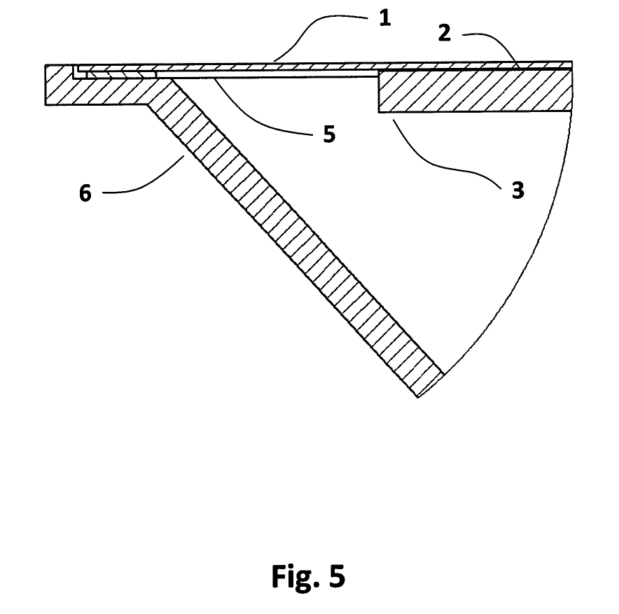

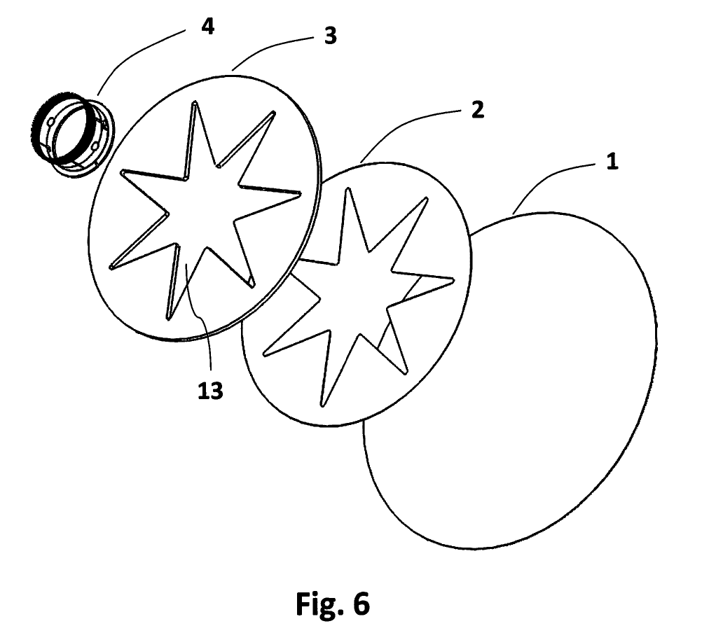

FIG. 4 provides a perspective view of a speaker membrane assembly with damping membrane 3 having a smaller outside diameter, to allow for a more flexible edge, of another embodiment. FIGS. 5-6 provide rear cross-section and exploded views, respectively, of the membrane assembly and shows supporting frame 6, with main membrane 1 forming a front, exterior, surface of the speaker, with main membrane 1 being formed of thin, stiff and solid materials.

As shown in FIG. 4, central star-shaped cutout 13 of damping membrane 3 allows voice coil 4 to directly attach to main membrane 1 through cut-out 13. The star central cutout 13 in damping membrane 3 also facilitates a gradual transition of material properties across the transition zone. Damping of vibrations is very low at the center and very high at the periphery of membrane 1, with the center of the membrane providing high-frequency sound reproduction, and the periphery only being capable of low-frequency sound reproduction, and absorbing high frequencies.

Star cutout 13 has an inside diameter between 1.1 to three times the size of voice coil 4, and an outside diameter of star cutout 13 is two and one-half times larger than the inside diameter. The membrane assembly provides a sound source of variable size, as a function of frequency, to ensure broad dispersion, i.e., off-axis frequency response. The source is acoustically small at high frequencies, with only a center area of the membrane assembly capable of reproducing high frequencies, and becomes acoustically larger as frequencies drop, with the periphery only being capable of reproducing low frequencies. For mid frequencies, star cutout 13 provides desired damping properties between the frequency extremes.

Star cutout 13 provides a gradual transition from the voice-coil attachment point, where all frequencies are reproduced, to the outer portion of the membrane, for optimized low-frequency reproduction only, with a transitional star-shaped zone of the transition region between the two, where high frequencies, typically above 5 kHz based on a particular application, are gradually attenuated.

Extension of damping membrane 3 up to an outer edge of main membrane 1 may result in a loudspeaker with a resonant frequency being too high, resulting in a loudspeaker with a resonant frequency higher than a lowest frequency that is to be reproduced in certain high-fidelity music reproduction applications. To overcome this potential concern, a damping membrane 3 with reduced outside dimensions is used, with main membrane 1 attached directly to supporting frame 6 using an adhesive bead or tape 5 (FIG. 5), leaving a gap between the speaker frame and the outer border or edge of the damping membrane 3.

In FIG. 6, both damping membrane 3 and adhesive layer 2 have a smaller diameter to provide an exposed flexible border. The flexible border provides a flat, elastic surround, functionally equivalent to that in conventional speakers, while also allowing for reduction and improved control of resonant frequency. Conventional speakers have a flexible surround with an outer edge of the cone attached to a supporting frame. In contrast, the present invention accomplishes the same effect with a flat membrane.

For practical embodiments of loudspeakers with a largest dimension of less than 500 mm overall, the recommended main membrane thickness is less than 0.8 mm for solid materials, or 6 mm for honeycomb or cellular panels, while the thickness of the damping membrane 3 must generally be greater than 2 mm, with this requirement being material-dependent.

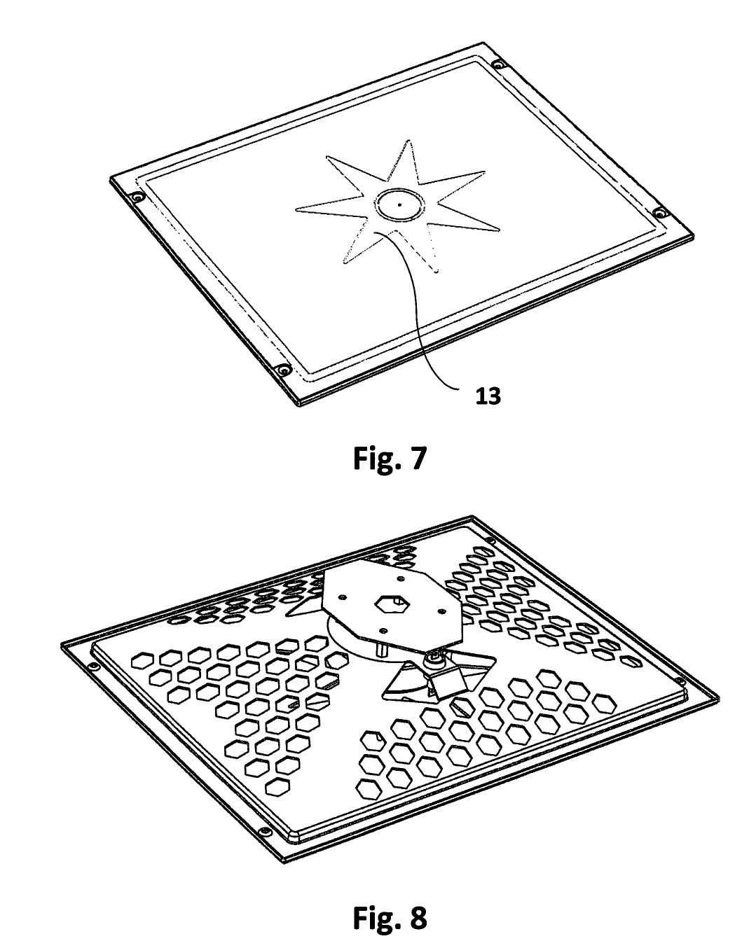

FIGS. 7 and 8 provide front and rear perspective views of a loudspeaker, with FIG. 7 showing the completely flat front face of the assembled loudspeaker and FIG. 8 showing a supporting structure of the speaker assembly. The membrane assembly of the loudspeaker of FIG. 7-8 includes a main membrane made of 0.5 mm thick FR4 fiberglass laminate and self-adhesive damping membrane made of 2 mm thick foamed PVC sheet.

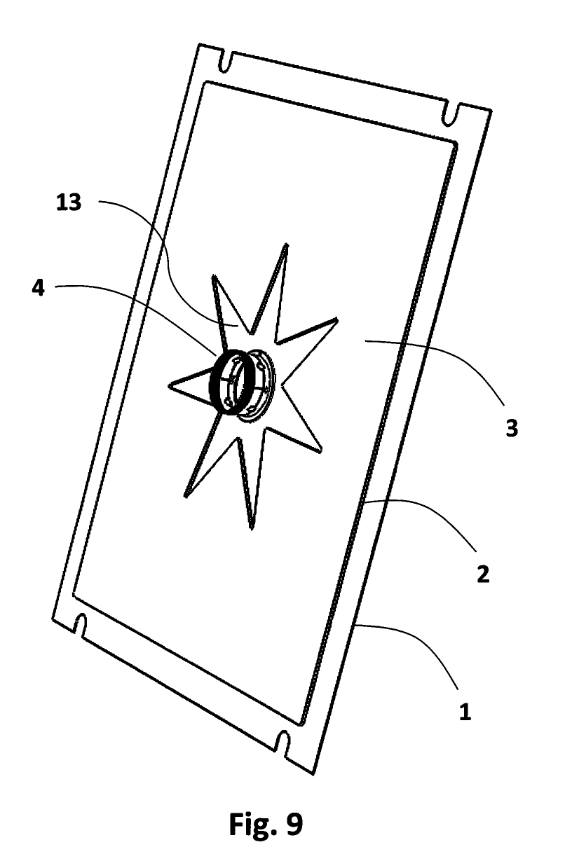

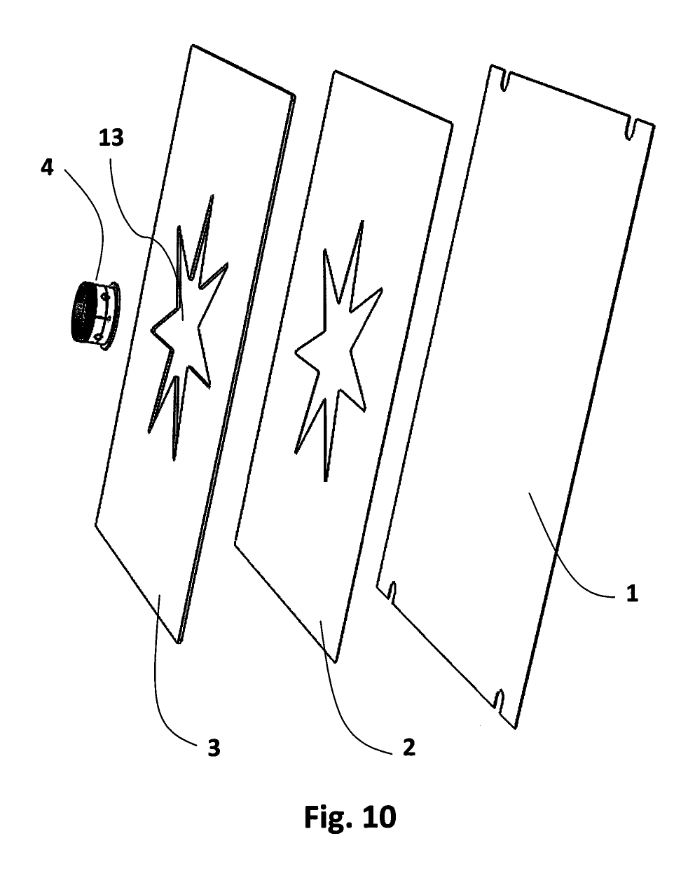

FIGS. 9 and 10 provide rear perspective and exploded views, respectively, of a loudspeaker speaker membrane assembly in a quadrilateral version of the membrane assembly with a flexible border. Main membrane 1, adhesive layer 2 and damping membrane 3 are arranged as described above in regards to the round versions, and the central hole, i.e. cutout, provides the same gradual transition between the center and the outer edge of the speaker.

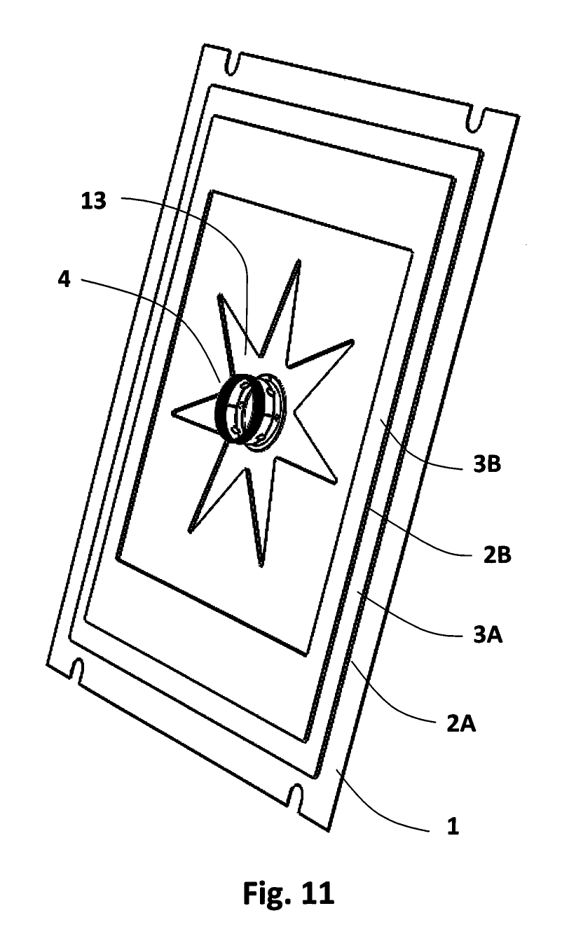

Embodiments include more than two layers to further control normal modes, particularly at low frequencies, with FIG. 11 providing a perspective view of a loudspeaker membrane assembly with an additional damping membrane, i.e., with a plurality of damping membranes in a stacked arrangement, with volumetric molded areas, i.e. areas in which damping membrane 3 lacks uniform thickness, to finely control the vibration characteristics of the membrane. FIG. 11 illustrates an additional refinement that improves flatness of the frequency response of membrane assembly by adding a second damping membrane 3b on a rear surface of a base damping membrane 3a, with a second adhesive layer 2b bonding the first and second damping membranes together, with the additional refinement being particularly beneficial at low and mid frequencies.

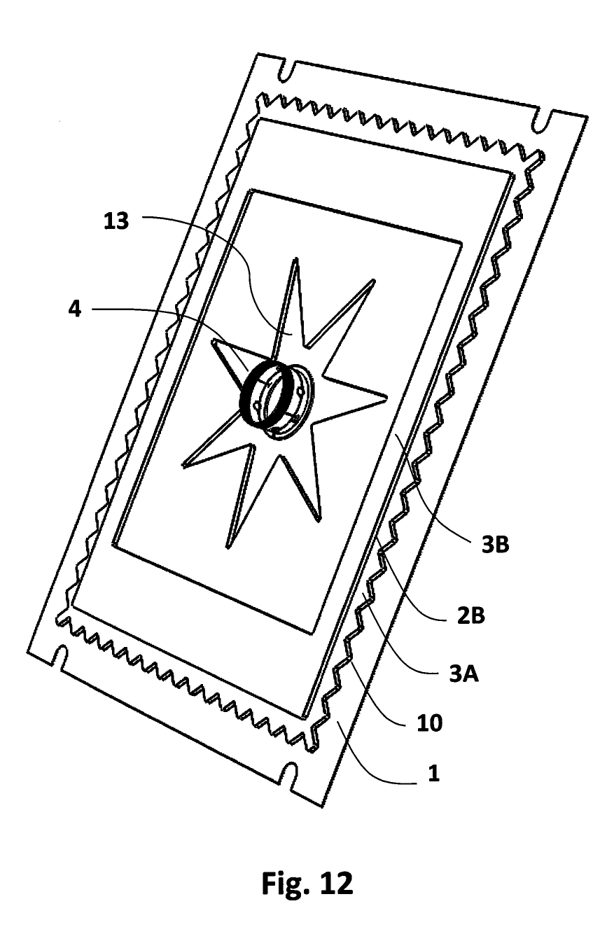

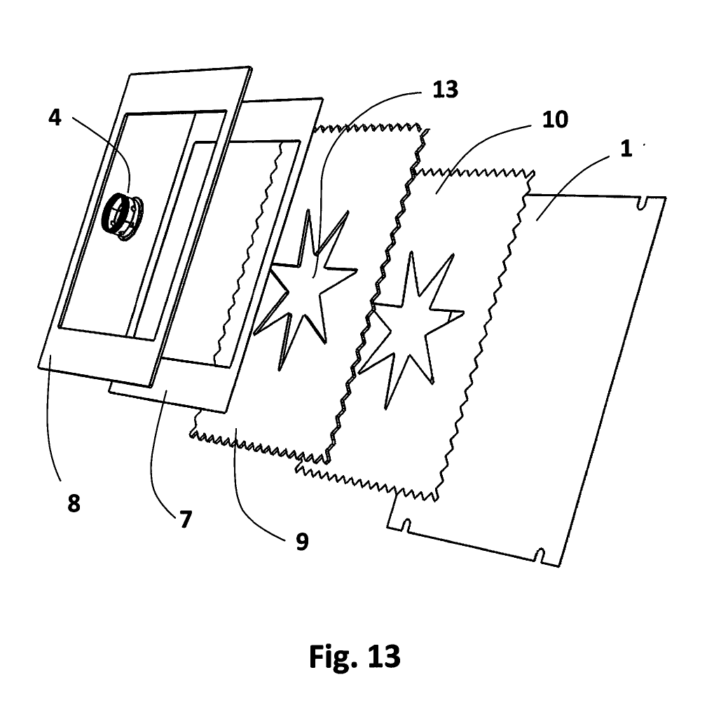

FIG. 12 provides a perspective view of a loudspeaker membrane assembly including a first damping membrane 3a having a serrated edge 10 that provides added flexibility and a smoother transition between main membrane 1 at high excursions, i.e., high displacement or movement of the membrane when listening to music at high volumes. FIG. 13 is an exploded view of the speaker membrane assembly of FIG. 12. The serrated edge 10 has a width of one to two times that of the exposed border, and provides a more flexible surround and longer life under high-power applications, with serrated edge 10 having, e.g., a width of up to 20% an outside dimension of the speaker or of smallest outside dimension of a rectangular shape speaker.

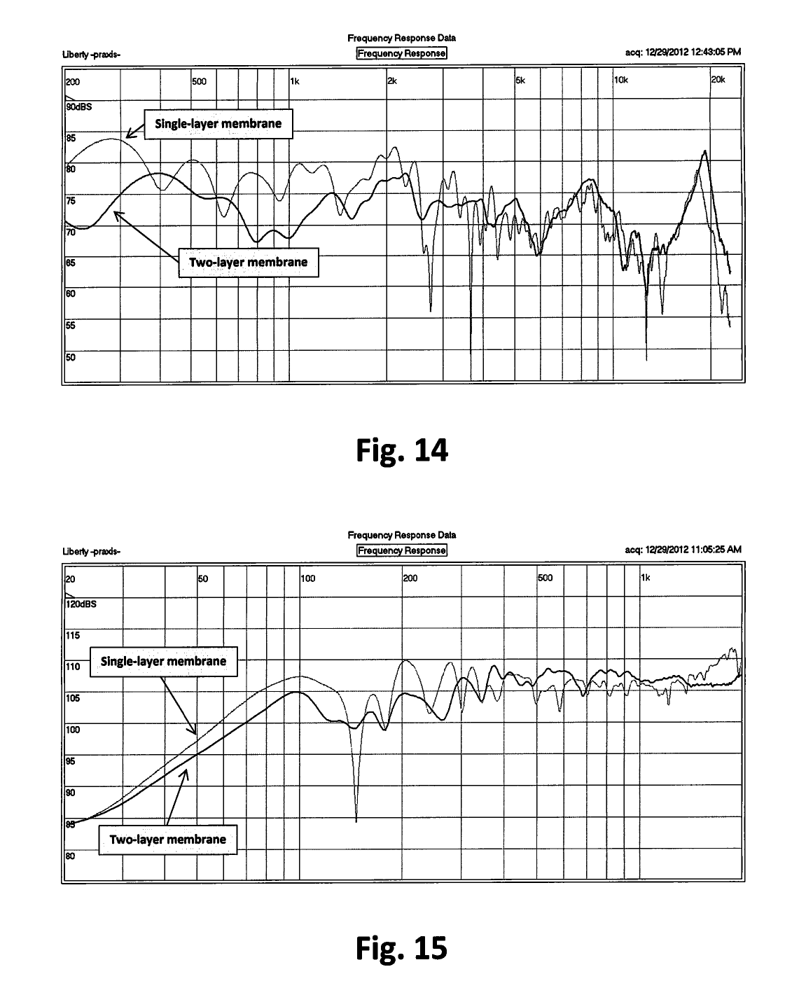

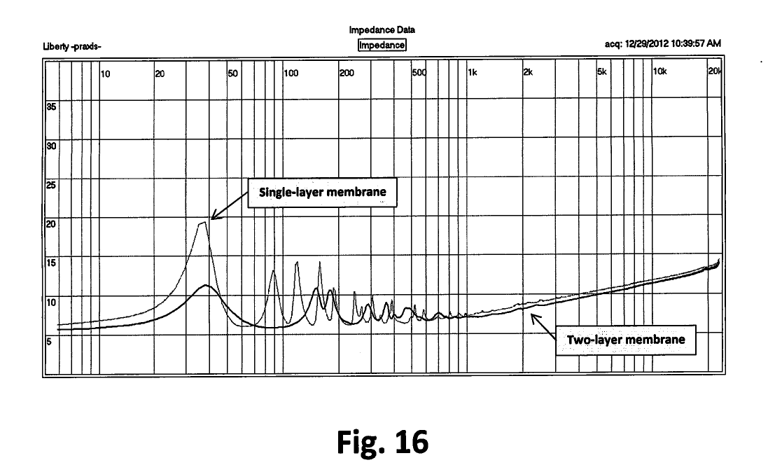

FIGS. 14 and 15 compare in-box far-field sound pressure level and in-box near-field sound pressure level, respectively, of the speaker of FIGS. 7-8 (solid line) to a conventional single-layer membrane (shaded line), and FIG. 16 compares free-air impedance of the speaker of FIGS. 7-8 (black line) to the single-layer membrane (shaded line). The substantial improvement provided by the addition of the secondary layer is evident in FIG. 14, in which a large number of narrow-band modes are eliminated, making the frequency-response curve considerably smoother at all frequencies, while maintaining the high-frequency extension, with a smooth frequency response curve being desirable for a loudspeaker for absence of unwanted resonance modes, with the frequency response curves of the single-layer membrane showing deeper dips, eliminated or reduced by the addition of the secondary layer with a star cutout.

Accordingly, a wide-frequency-range sound reproduction apparatus is provided that comprises a sound-radiating membrane; a secondary, damping membrane configured to dampen the sound-radiating membrane; and an adhesive layer positioned between the main and damping membranes, configured to bond both membranes.

In a preferred embodiment, the sound-radiating membrane of the wide-frequency-range sound reproduction apparatus has a modulus of elasticity greater than 15 GPa and the damping membrane has a modulus of elasticity less than 3 GPa. In addition, the damping membrane is preferably injection-molded on the sound-radiating membrane. In one embodiment, the sound-radiating membrane is flat and round in shape. In another embodiment, the damping membrane is round and has a star-shaped central cutout. In yet another embodiment, the sound-radiating membrane is flat and quadrilateral in shape.

In a further embodiment, the damping membrane is quadrilateral in shape and has a star-shaped central cutout. Preferably, each vertex of the star cutout is rounded with a radius between 1 and 10 percent of a length of a longest side of the star. In another embodiment, each vertex of the star cutout includes a straight cut having a chamfer between 1 and 10 percent of a longest side of the star. In a further embodiment, the adhesive layer has an elasticity configured to mechanically filter high frequencies. The sound-radiating membrane of the wide-frequency-range sound reproduction apparatus preferably has a stiffness at least ten times higher than a stiffness of the damping membrane.

Also provided is method of wide-frequency sound reproduction that includes driving, via a voice coil, a sound-radiating membrane, with an adhesive layer positioned between the membrane and a damping membrane, and with the adhesive layer configured to bond the sound-radiating membrane to the damping membrane. In the driving method, the damping membrane has a modulus of elasticity less than 3 GPa. Also in the driving method, the main membrane has a modulus of elasticity greater than 15 GPa. Further, the damping membrane is injection molded on the main membrane.

Also provided is a substantially flat loudspeaker membrane assembly, optimized for wide-frequency-range sound reproduction. The combination of a stiff and lightweight material for the main membrane with a direct voice-coil attachment region, and a secondary damping membrane allows for wide and uniform frequency response and low distortion reproduction equivalent to that of conventional speakers with a single voice coil. The choice of materials for the primary and secondary membranes allows for the modeling and optimization of the speaker for numerous wide-frequency-range applications.

The membrane assembly provided herein relates generally to acoustics, sound reproduction systems, and more particularly to transducers optimized for reproduction of a wide frequency range. Applications include but are not limited to high-fidelity, concealed speakers, home theater, background music, public address, computers, electronic gaming, headphones, sound reinforcement and paging.

While the invention has been shown and described with reference to certain exemplary embodiments of the present invention thereof, it will be understood by those skilled in the art that various changes in form and details may be made therein without departing from the spirit and scope of the present invention as defined by the appended claims and equivalents thereof.

1-20. (canceled)

21. A sound reproduction apparatus comprising:
a main membrane configured to reproduce sound;
a damping membrane configured to dampen the main membrane; and
an adhesive layer configured to bond the main membrane to the damping membrane,
wherein the damping membrane has a surface area forming at least twenty-five percent of an active sound radiating membrane.

22. The apparatus of claim 21, further comprising a hole through the damping membrane, wherein the hole is star-shaped.

23. The apparatus of claim 22, wherein the star-shaped hole is centrally positioned in the damping membrane and includes an odd number of vertices.

24. The apparatus of claim 23, wherein each vertex is rounded at a radius of between 1 and 10 percent of a length of a longest side of the star-shaped hole.

25. The apparatus of claim 22, wherein the star-shaped hole in the damping membrane includes a plurality of vertices, with each vertex including a straight cut with a chamfer between 1 and 10 percent of a longest side of the star-shaped hole.

26. The apparatus of claim 22, wherein the star-shaped hole of the damping membrane has an inside diameter between 1.1 to three times the size of a voice coil and has an outside diameter two and one-half times larger than the inside diameter.
